(19) United States
(12) Patent Application Publication
(10) Pub. No.: US 2006/0018260 A1
(43) Pub. Date: Jan. 26, 2006

(54) High density port complex protocol

(75) Inventors: Mark A. Richmond, Woodridge, IL (US); Daniel M. Conaway, Glen Ellyn, IL (US)

Correspondence Address: Jung-hua Kuo;Attorney At Law, PO Box 3275, Los Altos, CA, 94024, US

(73) Assignee: Tellabs Operations, Inc., A DELAWARE CORPORATION, Naperville, IL (US)

(21) Appl. No.: 10/895,583

(22) Filed: Jul. 21, 2004

(51) Int. Cl. H04L 12/26

(52) U.S. Cl. 370/236.2; 370/395.51; 370/907

(57) ABSTRACT

A protocol for intra-shelf exchange of SONET/SDH line and path alarm, and section and line digital cross-connect information is disclosed. The protocol encompasses a method including continual monitoring each SONET/SDH datapath channel for alarms by one or more line cards (e.g., optical line interface, electrical line interface), processing the results of the channel monitoring to consolidate and encapsulate SONET/SDH alarm data by the line cards, forwarding this data to a switch card, which makes switching decisions based on the data. The SONET/SDH line, path, and equipment fault information may be collected, filtered, and prioritized by the line cards with some knowledge of the protection scheme(s) being implemented by the switch card, and may be formatted into an efficient encoding of the quality of each path. This path quality information for each path may be encapsulated into eight-bit byte subfields within a bit-serial, synchronous, 1215-byte framed protocol which is transmitted to the switch card out-of-band, i.e., without altering the SONET/SDH signal itself. The switch card takes advantage of this encoding by performing simple comparisons between path quality bytes from associated working and protect path pairs, and consequently burdening its microprocessor only when a protection switch is necessary.

### BACKGROUND OF THE INVENTION

1. Field of the Invention

The present invention relates generally to optical and electrical port shelves within SONET/SDH transport equipment. More specifically, a protocol for intra-shelf exchange of SONET/SDH line and path alarm, and section and line digital cross-connect information is disclosed.

2. Description of Related Art

SONET alarm data collected by line cards are typically forwarded directly to a switch card in a port shelf within a port complex implementing BLSR (bi-directional line-switched ring) or UPSR (unidirectional path-switched ring) protection schemes. The SONET alarm data contain warning information regarding degradation in a SONET line or path as well as information regarding the need to switch traffic to a higher quality line or path. Upon receiving the SONET alarm data from the line cards, the switch card's microprocessor interprets and considers the SONET alarm data from each working and protect path (or line) pair to determine whether a switch from the active (working) path (or line) to an alternate (protect) path (or line) is necessary.

Over time, line and switch cards have become increasingly higher in density and bandwidth, i.e., line cards have many more line interfaces with higher bandwidth capacities. With higher density and bandwidth line cards, the switch card could receive massive quantities of SONET alarm data forwarded from the line cards within a short period of time, but needs to react and perform protection switch decisions for each path (or line) in the same fixed time as a lower-bandwidth port complex. For example, the number of paths (or lines) in a high density port shelf that the switch card monitors may be ten or more times that of a previous lower density port shelf. In addition, while microprocessor technology has advanced over time, it may not be feasible or cost-effective to scale the switch card's microprocessor to the extent that would alleviate this problem. Thus, the microprocessor of the switch card would be overwhelmed by the task of centrally processing massive quantities of unfiltered SONET alarm data and be placed under enormous computational burden.

Some high density port shelves implement paired-peer line card communication to cope with this problem in which line cards are paired to communicate with each other. While this solution reduces the maximum per-microprocessor burden by distributing the task of processing the SONET alarm data and making protection switching decisions to the line card microprocessors, the paired-peer line card communication approach limits the architecture of the system. For example, the more cost-effective 1-to-N, Mesh, or SNC protection schemes cannot be as easily implemented across the entire port shelf, since the protection scheme implementation is localized within each pair of line cards in the shelf.

Thus, it would be desirable to provide an improved system and method of path switching. Ideally, the system and method would reduce the computation-burden placed upon the microprocessor of the switch card without placing undue limitations on the architecture of the system.

### SUMMARY OF THE INVENTION

A protocol for intra-shelf exchange of SONET/SDH line and path alarm, and section and line digital cross-connect information is disclosed. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below.

The protocol encompasses a method including monitoring each SONET datapath channel for section/line/path alarms by a plurality of line cards, processing the results of the channel monitoring to consolidate and encapsulate SONET alarm data by the line cards forwarding to a switch card, and making switching decisions by the switch card based on the consolidated SONET path alarm data. Any suitable type(s) of line card interfaces may be implemented such as an optical line interface, an electrical line interface, or an interface implementing any format in which a SONET/SDH signal may be embedded, such as a proprietary system format, the ITU G.709 digital wrapper standard, etc. The protocol used in the described implementation to convey the section/line/path alarms is suitable for STS-1 and higher bandwidth signals and UPSR/BLSR protection schemes. However, lower bandwidth implementations such as VT-level UPSR or BLSR implementation may also utilize the protocol as described herein. Additional protection schemes, such as 1:N, Mesh, or SNC, and flexible pairing of working and protect line cards and paths (or lines) within the port shelf, may be implemented by appropriately augmenting the number and association of working and protect path quality field comparisons by the switch card.

The consolidated SONET alarm data may comprise a plurality of path quality subfields, each reflecting the number and degree of severity of at least one path alarm. In one embodiment, the alarms, faults, and other protection switch related messages associated with a given path are assigned a numerical priority ranking according to the rules of the protection scheme, and each path quality byte is transmitted in electrical format, from each line card to the switch card, within a bit-serial, synchronous, 1215-byte framed protocol. The switch card captures, stores, and performs a comparison of the path quality subfields which have been filtered and summarized by each line card for a working and a protect path in making the switching decisions to select a higher quality path. The switch card microprocessor may poll for changes of path quality field information, or may be interrupted on change of path quality field, or interrupted when the protect path quality exceeds the working path quality, which may further reduce the microprocessor burden. Finally, the switch card microprocessor makes the protection switch decision, and configures the switch to cross-connect the selected path/line traffic.

These and other features and advantages of the present invention will be presented in more detail in the following detailed description and the accompanying figures, which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is schematic diagram illustrating a port complex shelf supporting intermodule interconnects.

FIG. 2 is a schematic illustrating signaling on the intermodule interconnect in more detail.

FIG. 3 is an interface protocol/timing diagram.

FIG. 4 illustrates the byte numbering within a frame and the assignment of the fields within the frame according to one exemplary embodiment.

FIG. 5 illustrates an exemplary field bit definition of an optical line interface to a switching subsystem within the one-byte path quality field, per tributary.

FIG. 6 is a flowchart illustrating a process for employing the protocol for consolidating and encapsulating SONET path alarm data by the line cards for forwarding to the switch card in order for the switch card to make switching decisions.

### DESCRIPTION OF SPECIFIC EMBODIMENTS

A protocol for intra-shelf exchange of SONET/SDH line and path alarm, and section and line digital cross-connect information is disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

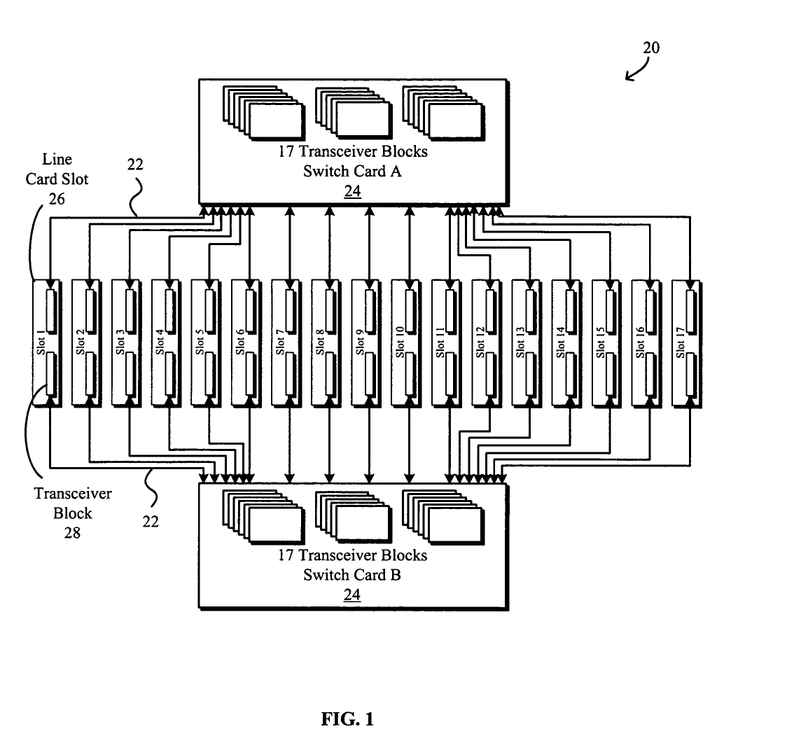

FIG. 1 is schematic diagram illustrating a port complex shelf 20 within a network element supporting internodule interconnects 22. The port complex shelf 20 includes two switch cards A and B 24 each represented by seventeen transceiver blocks, each corresponding to one of the seventeen line card slots 26. The line card slots 26, each represented in the diagram by two transceiver blocks 28 and each transceiver block 28 of a given line card slot 26 corresponding to one of the two switch cards 24, may be used by optical line cards, electrical line cards, and/or other suitable interface cards. Each transceiver block represents the hardware/software resources of each card for processing and exchanging a set of SONET/SDH alarm data between the line and switch cards 24, 26 via the protocol. Note that the transceivers shown are logical rather than physical representations and that the slot numbers are merely relative indicators of the total slot count rather than actual designations.

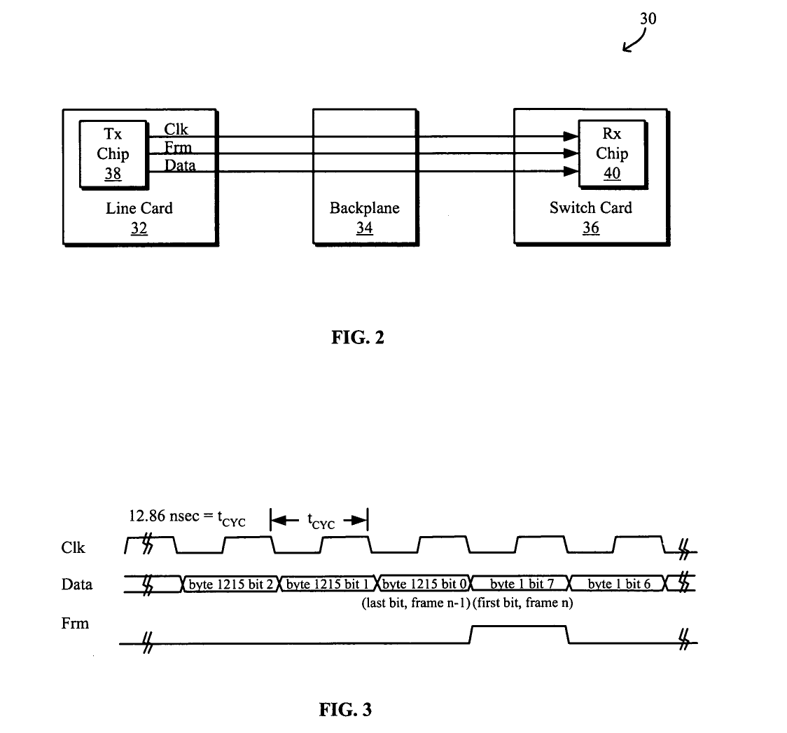

FIG. 2 is a block diagram illustrating the intermodule interconnect of the interface. The interconnect components generally include the line card 26, backplane 34 and switch card 24. The line card 26 includes a transmit chip 38 for transmitting signals. Similarly, the switch card 24 includes a receive chip 40 for receiving signals.

The switch and line cards 24, 26 of the port complex shelf 20 preferably utilize a protocol to communicate via the intermodule interconnects 22. The protocol is generally employed in equipment implementing BLSR or UPSR. The protocol is suitable for a high density port complex by consolidating the massive quantities of SONET alarm data that would otherwise be forwarded from the line cards 26 to the switch cards 24. Such consolidation reduces the amount of data received and interpreted or processed by the switch card 24 in order to make switching decisions, e.g., whether to move traffic from the active to an alternate path or line. Thus, the protocol reduces the computational burden placed on the microprocessor of the switch cards 24.

The protocol provides an exchange of SONET line and path alarms as well as section and line digital cross-connect information within a port complex. In particular, the protocol distributes the task to the line cards 26 to grade the severity of their own alarms against a common scale and to forward those grades to the switch cards 24. The switch cards 24 may then make a series of simple decisions based on the grades to select the higher quality path of each associated protection pair. In other words, the protocol permits the switch card 24 to make rapid protection-switching decisions on many lines and paths. The protocol includes a method for consolidating many individual path alarms into a single value for forwarding from a line card to the switch card in order for the switch card to make those switching decisions quickly. The protocol thus allows higher density of lines and paths in the port complex and more flexible protection schemes.

FIG. 3 is an interface protocol/timing diagram. The clock is 77.76 MHz in this example. The data and frame signals are synchronous to the clock and accompany the clock signal from one module to the other. This clock is synchronous to the transmitting module's internal clock source. When the receiving module detects a lack of transitions of the received clock, the receiving module ignores information received via the interface. For purposes of the path/line protection scheme, when the path quality protocol interface is determined to be unavailable or faulty, the switch card may rely on other types of information, or on previously-stored path quality information, as a basis for switching decisions. The data signal is synchronous to the accompanying clock and conveys the alarm and status information as described herein.

The frame signal is an active-high single-clock-cycle high-pulsewidth frame mark. It is synchronous to the accompanying clock signal and is high simultaneous with bit 7 of byte 1 of the data signal at the start of the frame. Its period is 9720 clock cycles, or 125 μs. Thus, the receiving module can use the frame signal to identify the first byte in the frame. The receiver declares itself in-frame when it has seen three consecutive (one-clock-wide) frame pulses spaced 9720 clock cycles apart from one another. The receiver declares itself out-of-frame when it does not see a frame pulse in the correct position for two consecutive 9720-clock-cycle intervals. When the receiver is out of frame, the receiving module declares the interface unavailable due to fault, and ignores all information received via the interface.

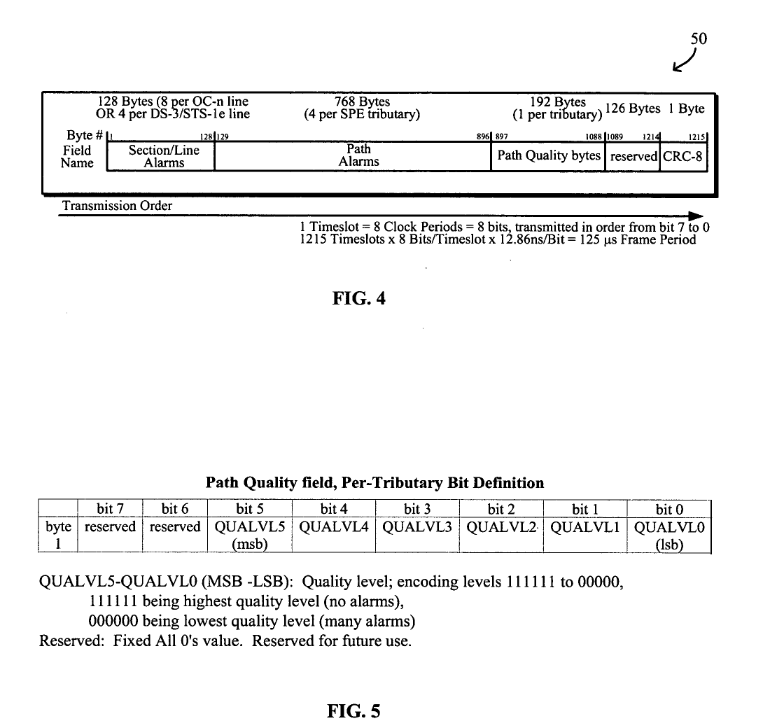

FIG. 4 illustrates the byte numbering within a frame 50 and the assignment of the fields within the frame according to one exemplary embodiment. As shown in FIG. 4, one frame contains 1215 eight-bit bytes. Preferably, bits within each byte are transmitted in order from bit 7 (MSB) to bit 0 (LSB) and bytes are transmitted in order from 1 to 1215. Frames may be transmitted continuously with no gaps in the transmission. Each frame includes various fields such as section/line alarms, path alarms, path quality bytes, and CRC-8. Each field has one or more bytes. Information in any field may be updated as frequently as each frame-time, i.e., approximately every 125 us. All interfaces transmit and receive this basic frame structure although each electrical line interface and optical line interface (or other interface types) will generally vary the information transmitted in these field based on their particular application. The definitions of each of these fields of the frame 50 are discussed below using the case of optical interfaces as an example.

Each non-reserved multi-byte subfield of the section/line alarm field corresponds to one optical or electrical line interface of the line card. The line card may convey valid section/line alarms or information via the section/line alarm field.

Path layer information which has not been consolidated and prioritized by the line card is conveyed via the path alarm field in the frame. Information is transferred on a per-STS-1/3c/12c/48c/192c-SPE basis. One four-byte subfield in the path alarm field of the frame corresponds to each SPE (SONET Payload Envelope) tributary. Optical line interfaces process path layer information and convey significant information to the switching subsystem. Though much of this more detailed information may be redundant with the Path Quality field information, it may be transmitted from the line card to switch card regardless, and may be considered reserved for use in other applications of the system.

Each non-reserved one-byte subfield of the path quality field corresponds to one STS-1 or STS-nC SONET path. FIG. 5 illustrates an exemplary field definition of an optical line interface to switching subsystem within the one-byte path quality field, per tributary. Each transmitted subfield value may be software-configurable by the line card's microprocessor. Alternately, section, line, and path alarms may be signaled by the framer device to the transceiver block within the line card and subsequently forwarded without line card microprocessor's intervention to the switch card as a quality level. On the receiving switch card's transceiver block, the quality level subfield is captured and compared with the same quality level field of the other affiliated path in the working/protect path pair. This comparison allows the switching subsystem to render a decision to switch traffic to a higher quality path and causes an indication to be presented to the microprocessor as a polled status bit or as an interrupt.

Preferably, there is no static definition of the meanings of the six quality level bits that are conveyed to the switch card other than that a high quality number indicates a path with higher quality than a path with a low number. Rather, there is a variable meaning to the bits that is based on a defect table configuration register bank (a microprocessor-accessible register set) that exists in each line card. This bank of registers allows the line card firmware to individually designate the severity of up to sixty-three fault types (in one example) and assign each of those faults a severity value relative to one another, based on the requirements of the protection scheme or of the current system configuration. If one or more faults are detected by the line card as it monitors the integrity of the SONET datapath, it weighs the aggregate of those fault conditions and sends the switch card a six-bit quality level figure reflecting the quality of the path. The switch card's transceiver logic block weighs the two quality values for the working/protect pair with a numerical magnitude comparison and alerts the switch card's microprocessor if the working path is of lower quality than the protect path.

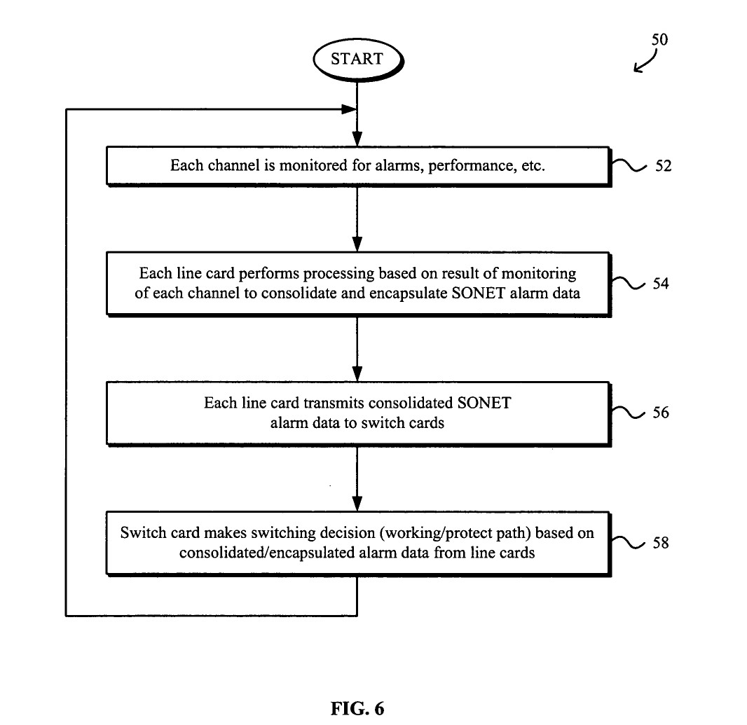

FIG. 6 is a flowchart illustrating a process 50 for employing the protocol for consolidating and encapsulating SONET path alarm data by the line cards for forwarding to the switch cards in order for the switch cards to make switching decisions. At block 52, each channel is monitored for alarms, performance, and various conditions. At block 54, each line card performs processing based on results of monitoring of each channel to consolidate and encapsulate SONET alarm data. Next, at block 56, the line cards forward the consolidated SONET alarm data to the switch cards. At block 58, the switch cards make switching decisions between the working and protect paths based on the consolidated/encapsulated data received from the line cards.

As is evident, the protocol described herein consolidates the massive quantities of alarm data that would otherwise be forwarded from the line cards to the switch cards for processing. Thus, the protocol also removes much of the computational burden from the microprocessor of the switch card by allowing the line cards to grade the severity of their own alarms and forward that grade to the switch card. The switch cards may then make a series of simple and quick decisions as to which path is of higher quality among the paths it monitors. Thus the protocol allows higher density of lines and paths in the port complex and more flexible protection schemes.

The protocol described above may be useful for implementing out-of-band communication of quality-level indication, such as via direct signaling across a backplane, or via any other suitable mechanism to communicate between the line card(s) and the switch card(s). While the protocol is described herein, by way of example, in terms of a port complex shelf within a network element that supports intermodule interconnects, it is to be understood that the protocol may be implemented in a SONET/SDH network element or portion thereof that includes one or more switching subsystems and one or more electrical and/or optical interface subsystems.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

What is claimed is:

1. A method for transmitting SONET and/or SDH alarm data within a port shelf, comprising:
monitoring a SONET/SDH datapath channel for alarms by a line card;
processing of results of the monitoring of the SONET/SDH channel to generate a quality-level indication by the line card that consolidates and encapsulates SONET alarm data;
forwarding the consolidated SONET/SDH path alarm data to a switch card; and
making switching decisions by the switch card based at least partially on the consolidated SONET/SDH path alarm data.

2. The method of claim 1, wherein the forwarding is an out-of-band communication in which SONET/SDH datapath signals transmitted from line card to switch card is unaltered by the forwarding.

3. The method of claim 1, wherein the switching decision is between associated pairs of working and a protect paths.

4. The method of claim 1, wherein a facility interface of the line card is selected from the group consisting of an optical line interface and electrical line interface.

5. The method of claim 1, wherein the switch card includes a microprocessor for making the switching decisions.

6. The method of claim 1, wherein the consolidated SONET/SDH alarm data is encapsulated in a bit-serial, synchronous, 1215-byte framed protocol.

7. The method of claim 1, wherein the consolidated SONET/SDH alarm data comprises a path quality subfield reflecting the number and degree of severity of at least one path alarm.

8. The method of claim 7, wherein the path quality subfield contains one byte for representing the number and degree of severity of at least one path alarm.

9. The method of claim 7, wherein the monitoring includes continual monitoring for SONET/SDH section/line/path alarms and errors and equipment faults, and wherein the line card weighs an aggregate of the alarms, errors, and faults detected during the monitoring.

10. The method of claim 7, wherein the switch card compares the path quality subfields for a working and a protect path in making the switching decisions to select a higher quality path.

11. A system for transmitting SONET/SDH alarm data within a port shelf, comprising:
a plurality of line cards configured to monitor each SONET/SDH datapath channel for alarms and to process results of the datapath channel monitoring to consolidate and encapsulate SONET/SDH alarm data; and
one or more switch cards configured to receive the consolidated and encapsulated SONET/SDH alarm data from the line cards and to make switching decisions at least partially based on the consolidated SONET/SDH path alarm data.

12. The system of claim 11, wherein the line cards and the switch cards communicate using a protocol.

13. The system of claim 11, wherein the switching decision made by the switch card is between a working and a protect path.

14. The system of claim 11, wherein a facility interface of the line card is selected from the group consisting of an optical line interface and an electrical line interface.

15. The system of claim 11, wherein the switch card includes a microprocessor for making the switching decisions.

16. The system of claim 11, wherein the consolidated SONET/SDH alarm data is encapsulated in a bit-serial, synchronous, 1215-byte framed protocol.

17. The system of claim 11, wherein the consolidated SONET/SDH alarm data comprises a path quality subfield reflecting the number and degree of severity of at least one path alarm.

18. The system of claim 17, wherein the path quality subfield contains one byte for representing the number and degree of severity of at least one path alarm.

19. The system of claim 17, wherein the monitoring includes continual monitoring for SONET/SDH section/line/path alarms and errors and equipment faults, and wherein each line card weighs an aggregate of these alarms, errors, and faults detected during said monitoring.

20. The system of claim 17, wherein the switch card compares the path quality subfields for a working and a protect path in making the switching decisions to select a higher quality path.
